(19) United States
(12) Patent Application Publication
(10) Pub. No.: US 2015/0203167 A1
(43) Pub. Date: Jul. 23, 2015

(54) Front Axle Retention for an Electric Cycle

(71) Applicant: Neal T. Saiki, Santa Cruz, CA (US)

(72) Inventor: Neal T. Saiki, Santa Cruz, CA (US)

(21) Appl. No.: 14/158,418

(22) Filed: Jan. 17, 2014

(51) Int. Cl. B62K 21/02; B62K 25/04

(52) U.S. Cl. CPC B62K 21/02; B62K 25/04; B62K 2204/00

(57) ABSTRACT

The present invention is generally directed towards systems for securely retaining an electric motor in a cycle fork, including: a surface feature and a slot, a motor with an axle positioned in the dropout, and a substantially flat insert disposed at least in part in the surface feature and including an opening into which the axle is at least in part positioned. Some embodiments may include a hub motor having an axle with a diameter of 12-14 mm with a non-round cross section with two flats on opposite sides, the axle being threaded; an aluminum fork including a dropout with a slot keyed to accept the axle, and a depression; a substantially flat metal plate 2-4 mm thick, positioned at least in part in the depression, and including an opening keyed to accept the axle; and a nut, threaded onto the axle.

### FIELD OF THE INVENTION

In general, the present invention is directed to an apparatus and system for connecting a front axle of an electric hub motor to a cycle frame. More specifically, the present invention is directed to a system for reinforcing a front cycle fork to withstand torsional forces exerted by a front electric motor, while providing a positive retention feature in accordance with various safety recommendations and requirements.

### BACKGROUND

The use of bicycles is known in the art. However, as urban areas become increasingly crowded, awareness of the environmental impact of internal combustion vehicles deepens, and the use internal combustion engines and other carbon-based energy sources becomes more expensive, the use and roles of bicycles has expanded.

As the use and roles of bicycles have expanded, various “clean” versions of providing additional power to such cycles have been used. For example, the addition of an electric motor to a cycle may provide for additional power when required or useful, without contributing to air pollution, the use of carbon-based energy sources, etc. Electric cycles are known in the art and becoming increasingly commonplace. In general, an electric cycle is a cycle (for example, a bicycle, tricycle, or a four-wheel or quadracycle) with an integrated electric motor that can be used for propulsion. Electric cycles may take any variety of form, for example a pedal-assist (or “pedelec”) or a power-on-demand. Pedal-assist cycles may be particularly desirable due to often being classified as cycles, rather than low-powered mopeds or motorcycles.

Various types of motors may be used in electric cycles, which may even be incorporated into one or more wheels of the cycle. Such motors may include, but are not limited to, hub motors that are disposed in the hub of a cycle wheel. However, because a hub motor exerts a rotational force on the axle of the wheel within which it is mounted, it causes a corresponding moment to be imparted to the axle. Accordingly, it is desirable to provide an axle for a hub motor that can withstand the forces exerted by the hub motor during repeated use and operation.

As the role of cycles expands, it is known in the art to modify or design cycles in order to accommodate cargo. A cargo cycle is a cycle that has a specific cargo area for carrying items such as groceries, passengers, packages, etc. However, cargo bicycles suffer various drawbacks, at least one of which is the amount of effort required by an operator to manually power a fully-laden cargo cycle to its destination. In areas with hills, for example, the effort required to operate a cargo cycle may at times outweigh the benefit. Accordingly, a cargo cycle that assists the user in powering the cycle is desirable.

If the cargo is held in a front portion of the cargo cycle, it may be advantageous or desirable to drive the front wheel of the cycle. However, front wheel forks are generally manufactured from softer and lighter materials (such as, but not limited to: aluminum, carbon fiber, titanium, and any combination or alloys of the same), which may not be suitable to handle the forces that may be exerted on the fork by a hub motor. Accordingly, it is desirable to provide a means of mounting a hub motor in a cycle fork generally manufactured from a softer or lighter material that will adequately resist torque applied to the fork from an electric motor.

Moreover, various safety recommendations and/or requirements include a positive retention feature for the front wheel of cycles. For example, the U.S. Consumer Product Safety Commission requires that “[f]ront wheel hubs that do not use a quick release device must have a positive retention feature that keeps the wheel on when the locking devices are loosened.” (See 16 C.F.R. §1512.12(c)). In other words, a front wheel must remain in place even if axle nuts are loose. Accordingly, it is desirable to provide a motor mount for a front cycle fork that remains positively retained even if the axle nuts are loose.

In addition, while various axle retainers for hub motors exist in the prior art, such retainers generally require at least two fasteners, thereby causing additional inconvenience during any removal and/or replacement of a wheel equipped with a hub motor.

### SUMMARY OF THE INVENTION

Aspects in accordance with some embodiments of the present invention may include a system for securely retaining an electric motor in a cycle fork, comprising: the fork, including a dropout comprising: a surface feature; and a slot; the motor, comprising an axle positioned in the dropout; and a substantially flat insert, disposed at least in part in the surface feature and comprising an opening, the axle being positioned at least in part in the opening.

Other aspects in accordance with some embodiments of the present invention may include a system for securely retaining an electric motor in a cycle fork, comprising: a hub motor comprising an axle with a specific cross section, the axle being at least in part threaded; a fork comprising a fork dropout with a slot keyed to accept the specific cross section of the axle and a depression disposed thereon; a substantially flat insert comprised at least in part of metal, disposed at least in part in the depression, and comprising an opening keyed to accept the specific cross section of the axle; and a nut, threaded onto the axle and at least partially holding the insert in the depression.

Some aspects in accordance with some embodiments of the present invention may include a system for securely retaining an electric hub motor in a cycle fork, comprising: a hub motor having an axle with a diameter of 12 mm or 14 mm with a non-round cross section comprising two flats on opposite sides, the axle being at least in part threaded; an aluminum fork comprising: a fork dropout with a slot keyed to accept the non-round cross section of the axle; and a depression; a substantially flat metal plate with a thickness between 2 mm and 4 mm, positioned at least in part in the depression, and comprising an opening keyed to accept the non-round cross section of the axle; and a nut, threaded onto the axle.

These and other aspects will become apparent from the following description of the invention taken in conjunction with the following drawings, although variations and modifications may be effected without departing from the spirit and scope of the novel concepts of the invention.

### BRIEF DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exploded view of a front axle insert for strengthening a cycle fork and positively retaining a front wheel, in accordance with some embodiments of the present invention.

FIG. 2 depicts an assembled system for strengthening a cycle fork and positively retaining a front wheel, in accordance with some embodiments of the present invention.

FIG. 3 illustrates an exploded view of a front axle insert for strengthening a cycle fork and positively retaining a front wheel, in accordance with some embodiments of the present invention.

FIG. 4 depicts an assembled system for strengthening a cycle fork and positively retaining a front wheel, used with a specialized fork for a cargo cycle, in accordance with some embodiments of the present invention.

FIG. 5 depicts an assembled system for strengthening a cycle fork and positively retaining a front wheel, used with a suspension fork, in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular. Note that the term “cycle” may include a bicycle, tricycle, pedelec, moped, or motorcycle.

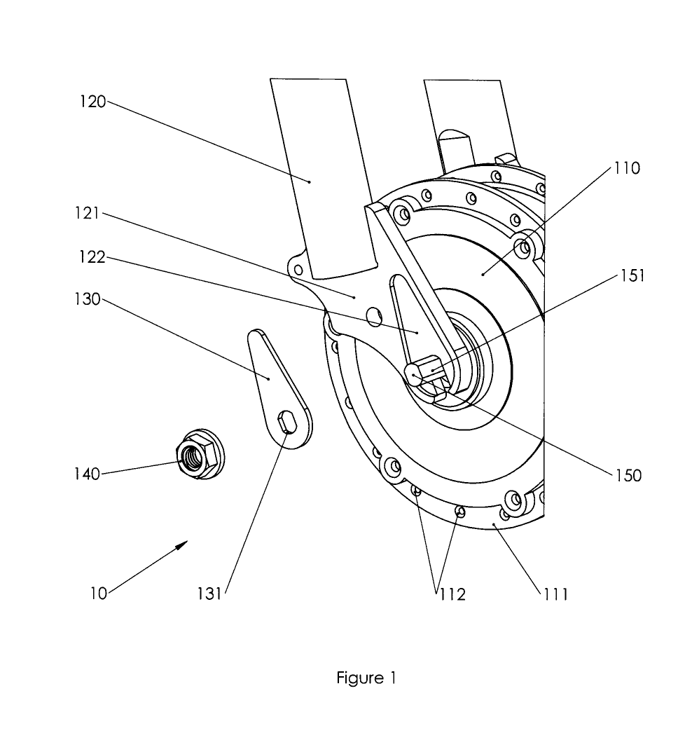

With reference to FIG. 1, a front axle insert system 10 for strengthening a cycle fork and positively retaining a front wheel, in accordance with some embodiments of the present invention will now be discussed. The system 10 may comprise a hub motor 110, a fork 120, a metal insert 130, an axle nut 140, and an axle 150. In general, the hub motor 110 comprise an outer surface or rim 111 that may, in accordance with some embodiments of the present invention, comprise a plurality of attachments for spokes. The hub motor 110 may be mounted in a slot or opening in the fork 120. More specifically, fork 120 may comprise a fork dropout 121, which may be a substantially flat or planar portion of the fork 120 onto which a wheel may be mounted. The axle 150 may positioned in the slot or opening in the fork dropout 121, and may be held in place by a retention device, such as axle nut 140. Note that it is contemplated that the axle 150 may be threaded or otherwise configured to mechanically receive and/or attach to the axle nut 140.

Note that axle 150 may be configured as a substantially cylindrical axle with flats 151 disposed thereon. Such flats 151 may be positioned in the slot or opening in the fork dropout 121 such that the front axle 150 may not freely rotate within the slot or opening in the fork dropout 121. The axle 15 may be of any size, though it is contemplated that the axle may be approximately twelve (12) or fourteen (14) millimeters in diameter, as this is a standard size. As the hub motor may provide a driving force to the front wheel, such retention may prevent slipping or rotation of the front axle 150, which may result in reduced drive force to the wheel.

In order to strengthen the fork 120 and/or the fork dropout 121 in order to prevent damage and/or unnecessary wear or fatigue caused by forces and torque applied from the hub motor 110, a metal insert 130 may be used. Metal insert 130 may be comprised of any suitable material that may resist the forces from the hub motor without excessive wear. Metal insert 130 may be of any suitable thickness, though the present invention contemplates a thickness between of two (2) to four (4) millimeters thick, and in accordance with some embodiments, a thickness of approximately three (3) millimeters. Metal insert 130 may comprise an opening 131 that may include flats in order to align with the axle 150. Metal insert 130 may be positioned in a depression 122 in the fork dropout 121. The depression 122 may prevent the metal insert 130 from rotating with the axle 150, and the force of any rotation may be applied from the metal insert 130 throughout the fork dropout 121.

Note that the fork dropout 121 may include additional surface features to support, connect, or hold in place the metal insert 130.

During operation, when the hub motor 110 applies a force to the rim 111 thereby rotating the wheel, an opposite force may be applied to the axle 150. The axle 150 may be prevented from rotating from the motor torque due to the flats 151 on the axle 150 being held by a corresponding flat on the fork dropout 121 and/or the flats 131 on the metal insert 130. The metal insert 130 may be prevented from rotating due to the depression 122 in the fork dropout 121. In this manner, the various forces that are applied to the cycle fork 120 due to the use of the hub motor 110 may be adequately handled by the fork 120 without excessive wear, and without requiring the entire fork 120 to be comprised of a stronger material. Accordingly, fork 120 may be manufactured from, for example, aluminum or a composite material, with a metal insert used to strengthen the connection with the hub motor.

In addition, the depression 122 in the fork dropout 121 may substantially surround the metal insert 130 (other than, for example, the slot into which the axle may be mounted). This substantial surrounding may prevent the metal insert 130 from easily sliding out of place, even if the axle nut 140 is loosened. If the metal insert 330 is held in place, the front wheel and hub motor may be correspondingly held in place. Accordingly, the metal insert 130 may therefore also provide a positive retention means that may retain the front wheel in place even if the axle nuts are loosened.

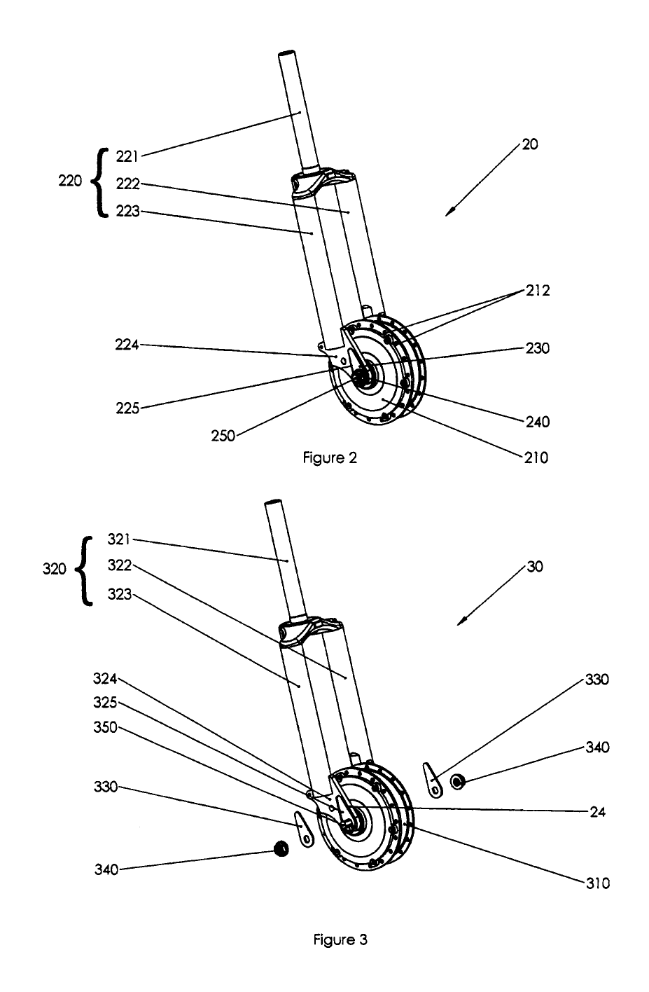

With reference to FIG. 2, an assembled system 20 for strengthening a cycle fork and positively retaining a front wheel, in accordance with some embodiments of the present invention will now be discussed. The system 20 may comprise a hub motor 210, a fork 220, a metal insert 230, an axle nut 240, and an axle 250. In general, the hub motor 210 may comprise a plurality of attachments for spokes 212. The fork 220 may comprise a top portion 221, which may be rotatably attached to a cycle frame and rotated to effectuate steering, a right fork 222 and a left fork 223. Each of the right fork 222 and left fork 223 may comprise a fork dropout 224 that may be, for example, substantially planar. The hub motor 210 may be mounted in a slot or opening in the fork dropout 224. The axle 250 may positioned in a slot or opening in the fork dropout 224, and may be held in place by a retention device, such as axle nut 240. Note that it is contemplated that the axle 250 may be threaded or otherwise configured to mechanically receive and/or attach to the axle nut 240.

Axle 250 may be configured as a substantially cylindrical axle with flats disposed thereon. Such flats may be positioned in the slot or opening in the fork dropout 224 such that the front axle 250 may not freely rotate within the slot or opening in the fork dropout 224. As the hub motor 210 may provide a driving force to the front wheel, such retention may prevent slipping or rotation of the front axle 250, which may result in reduced drive force to the wheel.

Metal insert 230 may be used to prevent damage and/or unnecessary wear or fatigue caused by forces and torque applied from the hub motor 210, and may be comprised of any suitable material that may resist the forces from the hub motor without excessive wear. Metal insert 230 may comprise an opening that may include flats in order to align with the axle 250. Metal insert 230 may be positioned in a depression 225 in the fork dropout 224. The depression 225 may prevent the metal insert 230 from rotating with the axle 250, and the force of any rotation may be applied from the metal insert 230 throughout the fork dropout 224.

As with the system 10 discussed above, during operation, when the hub motor 210 applies a force to rotate the wheel, an opposite force may be applied to the axle 250. The axle 250 may be prevented from rotating from the motor torque due to the flats on the axle 250 being held by a corresponding flat on the fork dropout 224 and/or the flats on the metal insert 230. The metal insert 230 may be prevented from rotating due to the depression 225 in the fork dropout 224. In this manner, the various forces that are applied to the cycle fork drop outs 224 due to the use of the hub motor 210 may be adequately handled by the fork without excessive wear, and without requiring the entire fork 220 to be comprised of a stronger material.

With reference to FIG. 3, an exploded view of a system 30 for a front axle insert for strengthening a cycle fork and positively retaining a front wheel, in accordance with some embodiments of the present invention will now be discussed. Similar to FIGS. 1 and 2 discussed above, the system 30 in FIG. 3 may comprise a hub motor 310, a fork 320, metal inserts 330, axle nuts 340, and an axle 350. The fork 320 may comprise a top portion 321, which may be rotatably attached to a cycle frame and rotated to effectuate steering, a right fork 322 and a left fork 323. Each of the right fork 322 and left fork 323 may comprise a fork dropout 324 that may be, for example, substantially planar. The hub motor 310 may be mounted in a slot or opening in the fork dropout 324. The axle 350 may positioned in a slot or opening in the fork dropout 324, and may be held in place by a retention device, such as axle nut 340. Note that it is contemplated that the axle 350 may be threaded or otherwise configured to mechanically receive and/or attach to the axle nut 340.

Axle 350 may be configured as a substantially cylindrical axle with flats disposed thereon. Such flats may be positioned in the slot or opening in the fork dropout 324 such that the front axle 350 may not freely rotate within the slot or opening in the fork dropout 324. As the hub motor 310 may provide a driving force to the front wheel, such retention may prevent slipping or rotation of the front axle 350, which may result in reduced drive force to the wheel.

Metal insert 330 may be used to prevent damage and/or unnecessary wear or fatigue caused by forces and torque applied from the hub motor 310, and may be comprised of any suitable material that may resist the forces from the hub motor without excessive wear. Metal insert 330 may comprise an opening that may include flats in order to align with the axle 350. Metal insert 330 may be positioned in a depression 325 in the fork dropout 324. The depression 325 may prevent the metal insert 330 from rotating with the axle 350, and the force of any rotation may be applied from the metal insert 330 throughout the fork dropout 324.

As with the systems 10 and 20 discussed above, during operation, when the hub motor 310 applies a force to rotate the wheel, an opposite force may be applied to the axle 350. The axle 350 may be prevented from rotating from the motor torque due to the flats on the axle 350 being held by a corresponding flat on the fork dropout 324 and/or the flats on the metal insert 330. The metal insert 330 may be prevented from rotating due to the depression 325 in the fork dropout 324. In this manner, the various forces that are applied to the cycle fork drop outs 324 due to the use of the hub motor 310 may be adequately handled by the fork without excessive wear, and without requiring the entire fork 320 to be comprised of a stronger material.

In addition, the depression 325 in the fork dropout 324 may substantially surround the metal insert 330 (other than, for example, the slot into which the axle may be mounted). This substantial surrounding may prevent the metal insert 330 from easily sliding out of place, even if the axle nut 340 is loosened. If the metal insert 330 is held in place, the front wheel and hub motor may be correspondingly held in place. Accordingly, the metal insert 330 may therefore also provide a positive retention means that may retain the front wheel in place even if the axle nuts are loosened.

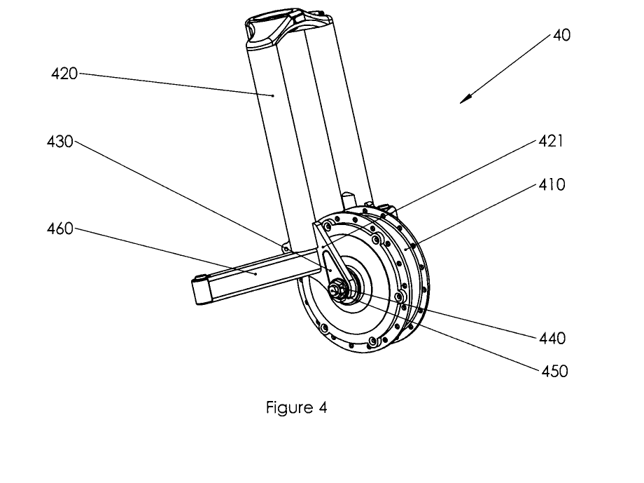

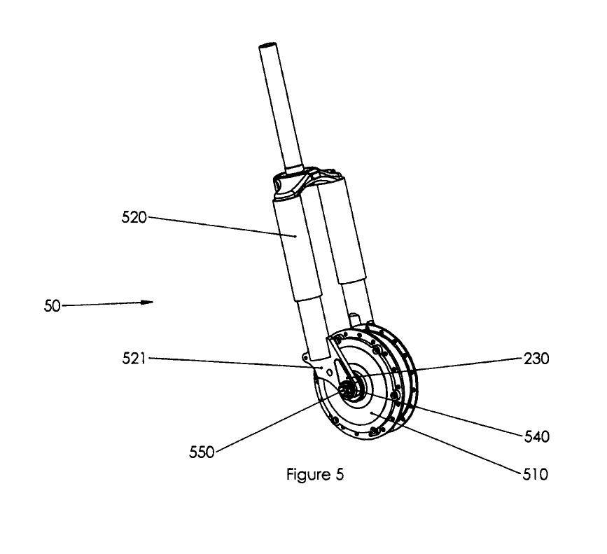

With reference to FIG. 4, an assembled system 40 for strengthening a cycle fork and positively retaining a front wheel, used with a specialized fork for a cargo cycle, in accordance with some embodiments of the present invention will now be discussed. System 40 may generally comprise a hub motor 410, a fork 420, a metal insert 430, an axle nut 440 and an axle 450. System 40 may additionally comprise a protrusion 460 which may be attached to the fork 420. Protrusion 460 may be attached to the fork 420 proximate to the fork dropout 421, and may extend substantially parallel to the fork 420. Protrusion 460 may be utilized to connect to pushrods and/or other types of steering components in order turn the fork 420 and the front wheel and motor 410. In the case of a cargo cycle, protrusion 460 may be utilized to receive steering inputs from a separate steering assembly.

Regardless of the form of the fork 420, the system 40 operates similarly to the systems discussed above. Metal insert 430 may be utilized to sit in a depression in the fork dropout 421, and may be configured with flats keyed to fit axle 450 and prevent rotation of the axle 450 within the metal insert 430. Metal insert 430 and the hub motor 410 may be held in place in the fork dropout 421 by any retention means, including but not limited to an axle nut 440 that may be threaded onto the axle 450. As the hub motor 410 applies a force to a wheel to rotate such wheel, an opposite force or toque may be resultant on the fork dropout 421. To prevent the fork dropout 421 from rounding out, wearing, or otherwise distorting or failing to properly hold the axle in place and prevent rotation, the metal insert 430 may be used. The torque of rotation of the hub motor 410 may be received by the metal insert 430, which may be hard enough to prevent rounding out of the flats. The metal insert 430 may itself be prevented from rotating by being positioned in a depression in the fork dropout 421. The use of the metal insert 430 may provide a means to prevent the fork dropout 421 slot or hole from wearing, as well as provide a means to distribute the force received from the hub motor 410 during operation across a larger area of the depression in the fork dropout 421.

In addition, as discussed above the depression in the fork dropout 421 may substantially surround the metal insert 430 (other than, for example, the slot into which the axle may be mounted). This substantial surrounding may prevent the metal insert 430 from easily sliding out of place, even if the axle nut 440 is loosened. If the metal insert 430 is held in place, the front wheel and hub motor 410 may be correspondingly held in place. Accordingly, the metal insert 430 may therefore also provide a positive retention means that may retain the front wheel in place even if the axle nuts 440 are loosened.

With reference to FIG. 5, an assembled system 50 for strengthening a cycle fork and positively retaining a front wheel, used with a suspension fork, in accordance with some embodiments of the present invention will now be discussed. Much as discussed above, the system 50 may comprise a hub motor 510 mounted in a fork 520. The fork 520 may be a suspension fork, for example, comprising hydraulic cushioning or spring resistance between the wheel and the attachment to a frame. In this manner, rider comfort and controllability of the cycle may be maintained even in rough terrain.

The system 50 may further comprise a metal insert 530 which may be positioned around an axle 540. An axle nut 550 or other attachment device may be used to retain the hub motor 510 in the proper position in the fork 520. Though not depicted in detail, the operation of the system 50 may be similar to that discussed above with regard to systems 10, 20, 30, 40, in that the metal insert 530 may be used to prevent rotation of the axle by dispersing any torque received from the hub motor 510 throughout the fork dropout 521. Moreover, the metal insert 530 may be used to provide a positive retention system to the hub motor 510 and front wheel, thereby providing safety redundancy in accordance with various safety requirements and/or recommendations.

It will be understood that the specific embodiments of the present invention shown and described herein are exemplary only. Numerous variations, changes, substitutions and equivalents will now occur to those skilled in the art without departing from the spirit and scope of the invention. For example, the axle may be maintained in place by various attachment devices other than a nut. The metal insert of the present invention may be utilized directly with a fork, and no fork dropout may be required. The metal plate may take any form or shape that may be convenient to match the fork or fork dropout into which it is mounted. Similarly, rather than having the metal plate or insert being positioned in a depression, it may be held in place between or by various protrusions on the fork or fork dropouts. Alternatively, the metal plate or insert may comprise one or more orifices or holes that may fit over protrusions on the fork or fork dropout, or may comprise one or more tabs that may be inserted into one or more orifices or holes in the fork or fork dropouts. Moreover, the present invention can be used for traditional wheel systems to provide a positive retention means without the use of a hub motor. For example, the present invention may permit front forks to be manufactured from lightweight and softer materials while providing an adequate attachment for a front wheel. Similarly, the specific shapes shown in the appended figures and discussed above may be varied without deviating from the functionality claimed in the present invention. Accordingly, it is intended that all subject matter described herein and shown in the accompanying drawings be regarded as illustrative only, and not in a limiting sense, and that the scope of the invention will be solely determined by the appended claims.

I claim:

1. A system for securely retaining an electric motor in a cycle fork, comprising:
the fork, including a dropout comprising:
a surface feature; and
a slot;
the motor, comprising an axle positioned in the dropout; and
a substantially flat insert, disposed at least in part in the surface feature and comprising an opening, the axle being positioned at least in part in the opening.

2. The system of claim 1, wherein the axle is at least in part threaded, and further comprising a nut that is attached to the axle.

3. The system of claim 1, wherein the surface feature is a depression in the dropout sized to accept at least a portion of the insert.

4. The system of claim 1, wherein the surface feature is one or more depressions or holes, sized to accept at least a portion of the insert.

5. The system of claim 1, wherein the axle has a cross-section, and wherein the insert is keyed to fit the cross-section of the axle.

6. The system of claim 1, wherein the fork is comprised at least in part of aluminum.

7. The system of claim 1, wherein the insert is comprised of a metal material.

8. The system of claim 1, wherein the insert positively retains the wheel in attachment to the fork.

9. The system of claim 1, wherein the fork is a suspension fork.

10. The system of claim 1, wherein during operation of the motor, torque received from the motor is applied at least in part to the insert, which distributes the torque around the depression.

11. The system of claim 1, wherein the substantially flat insert is between 2 mm and 4 mm thick.

12. The system of claim 1, wherein the axle is 12 mm or 14 mm in diameter, with two flats on opposite sides.

13. A system for securely retaining an electric motor in a cycle fork, comprising:
a hub motor comprising an axle with a specific cross section, the axle being at least in part threaded;
a fork comprising a fork dropout with a slot keyed to accept the specific cross section of the axle and a depression disposed thereon;
a substantially flat insert comprised at least in part of metal, disposed at least in part in the depression, and comprising an opening keyed to accept the specific cross section of the axle; and
a nut, threaded onto the axle and at least partially holding the insert in the depression.

14. The system of claim 13, wherein the specific cross-section of the axle is not round, thereby preventing rotation of the axle in the axle attachment portion and insert.

15. The system of claim 13, wherein the fork is configured to receive steering inputs from one or more pushrods from a steering assembly.

16. The system of claim 13, wherein the fork is comprised at least in part of aluminum.

17. The system of claim 13, wherein during operation of the hub motor, torque is transmitted from the hub motor to the fork, and is resisted at least in part by the insert.

18. The system of claim 13, wherein the substantially flat insert is between 2 mm and 4 mm thick.

19. The system of claim 13, wherein the axle is 12 mm or 14 mm in diameter, with two flats on opposite sides.

20. A system for securely retaining an electric hub motor in a cycle fork, comprising:
a hub motor having an axle with a diameter of 12 mm or 14 mm with a non-round cross section comprising two flats on opposite sides, the axle being at least in part threaded;
an aluminum fork comprising:
a fork dropout with a slot keyed to accept the non-round cross section of the axle; and
a depression;
a substantially flat metal plate with a thickness between 2 mm and 4 mm, positioned at least in part in the depression, and comprising an opening keyed to accept the non-round cross section of the axle; and
a nut, threaded onto the axle.
